(19) United States
(12) Patent Application Publication
(10) Pub. No.: US 2013/0250727 A1
(43) Pub. Date: Sep. 26, 2013

(54) METHOD OF SEISMIC SOURCE SYNCHRONIZATION

(71) Applicants: Thomas F. Phillips, Richmond, TX (US); Keith Radcliffe, Meadows Place, TX (US); Bernard Maechler, Sugar Land, TX (US)

(72) Inventors: Thomas F. Phillips, Richmond, TX (US); Keith Radcliffe, Meadows Place, TX (US); Bernard Maechler, Sugar Land, TX (US)

(73) Assignee: INOVA LTD., Grand Cayman (KY)

(21) Appl. No.: 13/621,632

(22) Filed: Sep. 17, 2012

Related U.S. Application Data
(60) Provisional application No. 61/535,770, filed on Sep. 16, 2011.

(51) Int. Cl. G01V 1/22

(52) U.S. Cl. CPC G01V 1/22
USPC 367/76

(57) ABSTRACT

A method of controlling communications relating to seismic data acquisition may include synchronizing the start of one or more seismic energy sources via a communication protocol. The protocol may be generated at a seismic recording system, source control software running on a processor, or generated from a seismic energy source encoder. The protocol may consist of an encoder message that includes start information and that is combined with a request for information contained at the seismic energy source. The requested information may be sent in a decoder message that is returned in synchronized manner.

### CROSS-REFERENCE TO RELATED APPLICATIONS

This application claims priority from U.S. Provisional Application Ser. No. 61/535,770 filed Sep. 16, 2011, the disclosure of which is fully incorporated herein by reference in its entirety.

### BACKGROUND OF THE DISCLOSURE

1. Field of the Disclosure

This disclosure relates generally to systems and methods that employ communication protocols to reduce message collisions and expedite seismic data acquisition activities.

2. Background of the Art

Seismic surveys are conducted to map subsurface structures to identify and develop oil and gas reservoirs. Seismic surveys are typically performed to estimate the location and quantities of oil and gas fields prior to developing (drilling wells) the fields and also to determine the changes in the reservoir over time subsequent to the drilling of wells. On land, seismic surveys are conducted by deploying an array of seismic sensors (also referred to as seismic receivers) over selected geographical regions. The seismic sensors (geophones or accelerometers) are placed or coupled to the ground in the form of a grid. An energy source is used at selected spaced apart locations in the geographical area to generate or induce acoustic waves or signals (also referred to as acoustic energy) into the subsurface. The acoustic waves generated into the subsurface reflect back to the surface from subsurface formation discontinuities, such as those formed by oil and gas reservoirs. The reflections are sensed or detected at the surface by the seismic sensors and recorded. The sensing, processing and recording of the seismic waves is referred to as seismic data acquisition. Two-dimensional and/or three-dimensional maps of the subsurface structures (also referred to as the “seismic image”) are generated from the recorded seismic data. These maps are then used to make decisions about drilling locations, reservoir size, pay zone depth and estimates of the production of hydrocarbons.

The present disclosure provides communication protocols for facilitating and managing efficient seismic exploration activity for obtaining seismic information.

### SUMMARY OF THE DISCLOSURE

A method of controlling communications relating to seismic data acquisition may include synchronizing the start of one or more seismic energy sources via a communication protocol. The protocol may be implemented at central location, in a seismic recording system, seismic energy source control software running on a processor, or implemented in a seismic energy source encoder. The protocol may be implemented in various kinds of seismic energy source controllers and/or support equipment. The protocol may consist of an encoder message that includes start information in combination with requests for information contained at various seismic energy sources. The requested information may be returned in a decoder message that is transmitted synchronized manner. This method is designed so that several encoder messages can be sent, in sequence, such that several sets of seismic energy sources with the related communications can be conducted in an overlapping manner. Thus, efficient seismic exploration operations can be conducted in a continuous manner, depending upon the physical limitations of the available equipment. (See FIG. 4)

The encoder message may include any number of commands and request types. For example, the encoder message may include a start command and a request of a status of at least one seismic energy source. In another example, the encoder message may include a start command combined with a request of quality control information relating to a previous initiation of at least one seismic energy source controller. In yet another example, the encoder message may include a start command, combined with a request of current or previous status of one or more seismic energy source controllers, and a request of quality control information from at least one previous initiation of at least one seismic energy source controller.

In some embodiments, the method of controlling communication may include synchronizing the return of seismic energy source controller information during a synchronization of the initiation or start of one or more seismic energy source controllers. The seismic energy source controller information may include the current or previous status of one or more seismic energy source controllers. This status information for all the seismic energy source controllers may be dynamically assigned a temporary transmission timeslot. The seismic energy source controller information may include one or more quality control data from one or more previous initiations of one or more seismic energy source controllers. This status information for all the seismic energy source controllers may also be dynamically assigned a temporary transmission timeslot.

In some embodiments, a navigation system, a computer with a processor, or seismic energy source controller may be used to combine two or more current or previous status messages from one or more seismic energy source controllers. The combined status messages may be transmitted via a protocol used for synchronizing one or more seismic energy source controllers and returning the information in a synchronized manner.

The above data communications may be transported wirelessly and/or with wired connections. The communication protocol may consist of an analog or digital protocol or method of synchronization.

Examples of certain features of the systems, methods and apparatus disclosed herein have been summarized rather broadly in order that detailed description thereof that follows may be better understood, and in order that the contributions to the art may be appreciated. There are, of course, additional features of the disclosure that will be described hereinafter and will form the subject of the disclosure. The summary provided herein is not intended to limit the scope.

### BRIEF DESCRIPTION OF THE DRAWINGS

The novel features of this disclosure, as well as the disclosure itself, will be best understood from the attached drawings, taken along with the following description, in which similar reference characters generally refer to similar elements, and in which:

FIG. 1 shows a cable seismic data acquisition system that may utilize the disclosed communication protocols;

FIG. 2 is a representation of a wireless seismic data acquisition system that may use the disclosed communication protocols;

FIG. 3 shows the communication between a seismic energy source encoder and decoder according to one embodiment of the present disclosure; and

FIG. 4 shows illustrative sweeps according to one embodiment of the present disclosure.

### DETAILED DESCRIPTION OF THE EMBODIMENTS

The present disclosure relates to devices and methods for controlling activities relating to seismic data acquisition. The present disclosure may be implemented in embodiments of different forms. The drawings shown and the descriptions provided herein correspond to certain specific embodiments of the present disclosure for the purposes of explanation of the concepts contained in the disclosure with the understanding that the present disclosure is to be considered an exemplification of the principles of the disclosure, and is not intended to limit the scope of the disclosure to the illustrated drawings and the description herein.

As will be discussed in greater detail below, the present disclosure provides methods for synchronizing the start of one or more seismic energy source controllers via a communication protocol transmitted by wire and/or wirelessly. The communication protocol may use an analog or digital protocol or method of synchronization. A protocol may be transmitted from a seismic energy source encoder (e.g., a seismic recording system, source control software running on a processor) and/or generated from a seismic energy source encoder. The protocol synchronizes start information and combines with the start information a request for information contained at the seismic energy source controller. The requested information will be returned in synchronized manner.

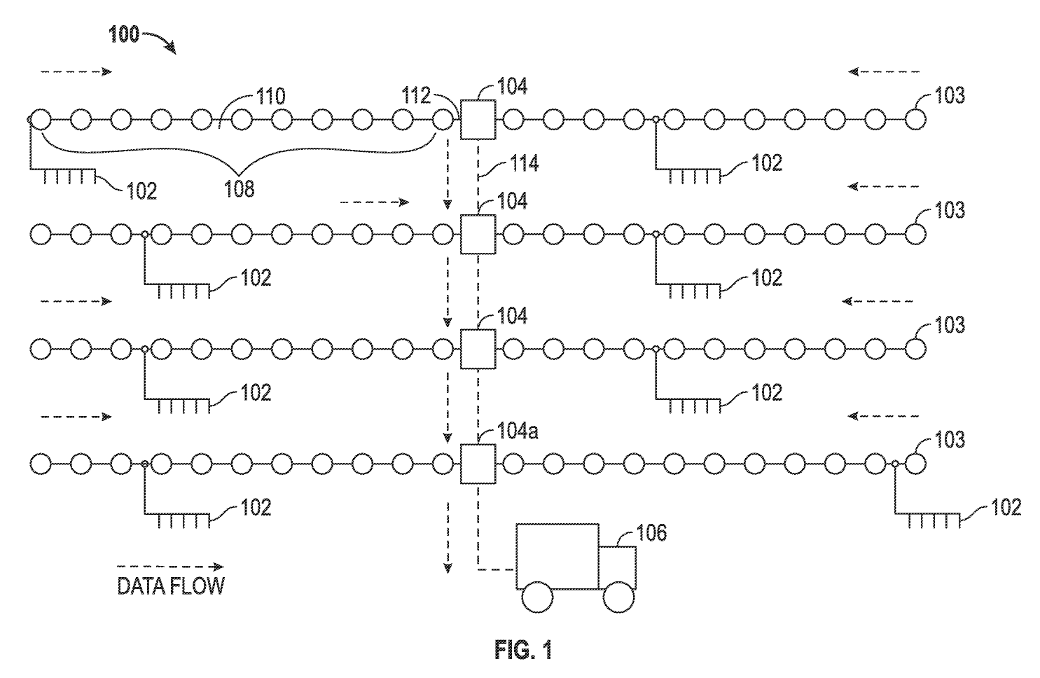

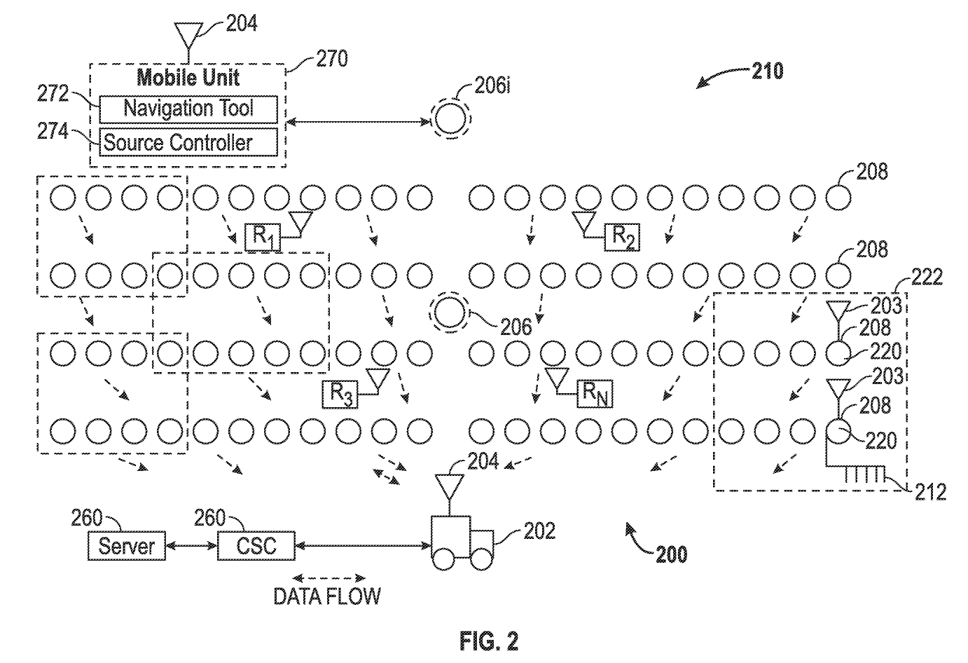

FIGS. 1 and 2 depict illustrative, but not exclusive, seismic data acquisition systems that may implement the methods of the present disclosure. The basic components of these systems are discussed in greater detail below. Thereafter, the methods for controlling/synchronizing communications for these systems are described

FIG. 1 depicts a conventional cable seismic data acquisition system 100. Such a system includes an array (string) of spaced-apart seismic sensor units 102. Each string of sensors is typically coupled via cabling to a data acquisition device 103, and several of the data acquisition devices and associated string of sensors are coupled via cabling 110 to form a line 108, which is then coupled via cabling 112 to a line tap or (crossline unit) 104. Several crossline units 104 and associated lines are usually coupled together by cabling, such as shown by the dotted line 114. The sensors 102 are usually spaced between 10-50 meters. Each of the crossline units 104 typically performs some signal processing and then stores the processed signals as seismic information. The crossline units 104 are each typically coupled, either in parallel or in series, with one of the units 104a serving as an interface between the central controller or control unit (CU) 106 and all crossline units 104. This system may use wired communication media, e.g., RS232, Ethernet, RS485, USB, etc.

Referring to FIG. 2, a representation of a wireless seismic data acquisition system 200 is shown according to one embodiment of the present disclosure. The system 200 includes a central controller or control unit (CU) 202 in data communication with each of a number of wireless field station units (FSU) or sensor stations 208 forming an array (spread) 210 for seismic data acquisition. The wireless communication between the central controller 202 with the FSUs may be direct bi-directional wireless communication or via an intermediate unit such as a repeater unit (RU) (not shown). Each sensor station 208 includes one or more sensors 212 for sensing seismic energy. The sensors 212 may be any suitable seismic sensors, including geophones, and one or more component accelerometers.

Direct communication as used herein refers to individualized data flow as depicted in FIG. 2 by dashed arrows. A wireless communication system can be a VHF, UHF, WiFi, or other wireless radio communication system. The data flow can be bi-directional to allow one or more of: transmission of command and control instructions from the central controller 202 to each wireless sensor station 208; exchange of quality control and other data between the central controller 202 and each wireless sensor station 208; and transmission of status signals, operating conditions and/or selected pre-processed seismic information from each wireless sensor station 208 to the central controller 202. The communication might be in the form of radio signals transmitted from and received by the sensor stations 208 and central controller 202 via suitable antennas 203 and 204 respectively.

In an active mode, the system 200 uses one or more seismic energy sources 206 to generate seismic energy of known characteristics, such as magnitude, frequency etc., at known locations in the seismic spread to impart seismic energy into the subterranean formation. A representative seismic energy source is designated with numeral 206i. Typically, activation (or more commonly, “shooting” or “firing”) of the source 206i is initiated locally by a mobile unit 270.

One illustrative energy source is a vibrator truck. Vibrator trucks support a heavy base plate that is connected to an inertia mass. The inertia mass contains a linear actuator that reciprocates the base plate along a vertical or horizontal axis in reaction to the momentum of the inertia mass. The reciprocating base plate injects a vibratory wave train into the earth. A programmable controller controls the force and frequency of the signal generated by the inertia mass.

Another illustrative energy source is an accelerated weight-drop truck. A weight-drop truck is a vehicle mounted ground impact which can used to provide the seismic source. A heavy weight is raised by a hoist at the back of the truck and dropped, possibly about three meters, to impact (or “thump”) the ground. To augment the signal, the weight may be dropped more than once at the same spot, the signal may also be increased by thumping at several nearby places in an array whose dimensions may be chosen to enhance the seismic signal by spatial filtering.

Still other illustrative energy sources include explosive sources, such as dynamite, and compressed gas source. It should be understood, however, that any device that generates usable seismic energy may be an energy source.

In one embodiment, an operator in the mobile unit 270 utilizes a navigation tool 272 to navigate to a selected source location and using a seismic energy source controller 274 operates the vibrator associated with the mobile unit to impart seismic energy into the subterranean formation. In another aspect, a mobile unit may be used to controllably fire explosive sources. To navigate the terrain and to determine the precise location coordinates of the source, the navigation tool 272 can be equipped with a global positioning satellite (GPS) device and/or a database having predetermined coordinates for each of the locations at which the source is to be activated. The source controller 274 can be programmed to receive and transmit information such as instructions to make the source 206i ready for firing, fire the source 206i, provide data indicative of the location of the mobile unit 270, the arming status of the source 206i, and data such as return shot attributes.

The central controller 202, the central station computer (CSC) 260 and a central server 280 exert control over the constituent components of the system 200 and direct activities of the operators and devices during the operation of the system 200. The server 280 can be programmed to manage data and activities over the span of the seismic surveying activities, which can include daily shooting sequences, updating the shots acquired, tracking shooting assets, storing seismic data, pre-processing seismic data and broadcasting corrections. CSC 260 may be integral with the CU 202. The central controller 202 also may act as a central radio unit. For large fields, radio antennas and repeater transceivers may also be deployed at selected field locations as described below.

As will be discussed in greater detail below, operating methods in accordance with the present disclosure eliminate the use of polling seismic energy source controllers with request messages transmitted when conducting seismic surveys using the illustrated systems, or other similar systems. As used herein, the term “encoder” refers to the recording system (e.g., controller 202 of FIG. 2) and the term “decoder” generally refers to a seismic energy source (e.g., source 206 of FIG. 2).

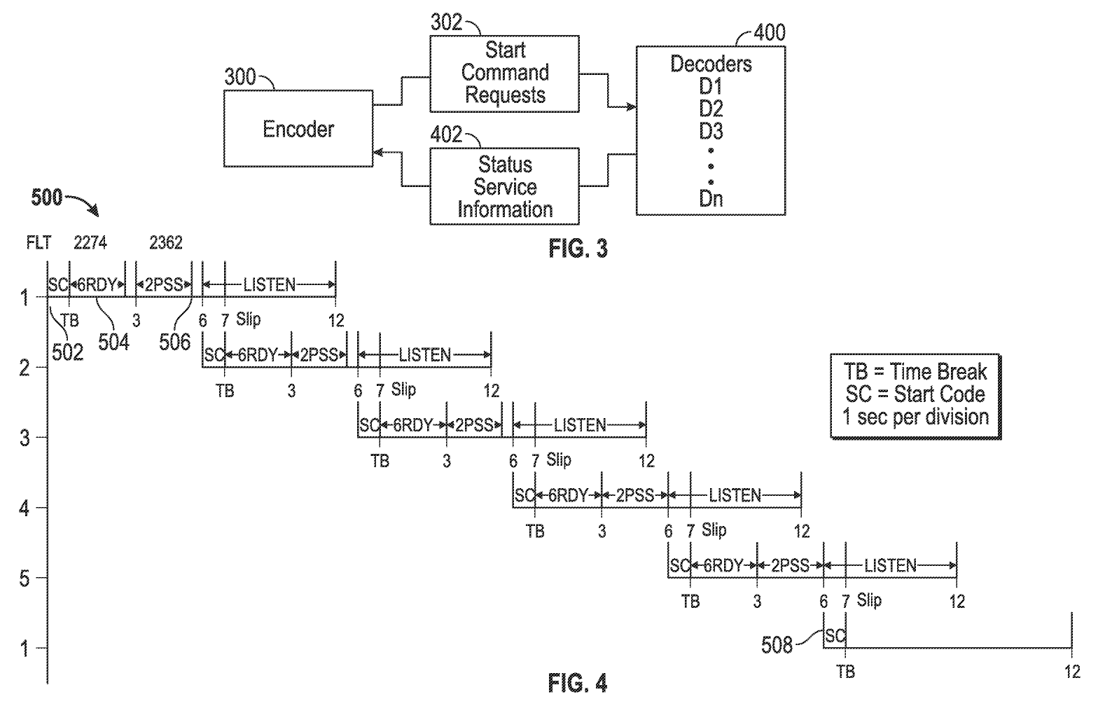

Referring now to FIG. 3, there is schematically illustrated an encoder 300 and a plurality of decoders 400 (D1-Dn). D1-Dn may be for, example, vibration trucks. The encoder 300 may be a recording system and the decoder 400 may be the seismic sources. The encoder 300 may transmit messages 302 to the decoders 400 and the decoders 400 may transmit or “return” messages 402 to the encoder 300. Illustrative encoder messages 302 may include, but not are not limited to, ‘start,’ ‘request status,’ and ‘request information.’ Illustrative decoder messages 402 may include, but not are not limited to ‘status,’ and ‘service information.’ The status may include, but not be limited to, the GPS location of the source, vibrator truck actuator lift status, fire line test, uphole geophone test status, and the proper positioning of a weight in an accelerated weight drop system.

In order to avoid message collision, decrease the amount of radio communication time, and minimize the time to complete tasks, a communication protocol may be used that combines the encoder message 302 requests (e.g., request for status message and quality control information) with start commands. The communication protocol further synchronizes the decoder messages 402.

One exemplary communication protocol synchronizes the start command messages sent to one or more seismic sources. The protocol may be generated at a seismic recording system, source control software running on a processor, or generated from a seismic source encoder. The protocol may consist of an encoder message 302 that includes start information and is combined with a request for information contained at the seismic source. The requested information may be sent in a decoder message 402 that is returned synchronously.

The encoder message 302 may be include any number and combination of commands and request types. For example, the encoder message 302 may include a start command and a request of a status of at least one seismic source. In another example, the encoder message 302 may include a start command and a request of quality control information relating to a previous initiation of at least one seismic source. In still another example, the encoder message 302 may include a start command, a request of current or previous status of one or more seismic sources, and a request of quality control information from at least one previous initiation of at least one seismic source.

FIG. 4 illustrates exemplary sweeps 500 wherein an encoder 300 exchanges information with decoders 400. As shown, a start command message 502 initiates the seismic operation. A time slot 504 may be dynamically assigned to receive ready signals, and a time slot 506 may be dynamically assigned to receive status information. By “dynamic” or “dynamically,” it is meant that the time-slot assignments are temporary and assigned “on the go”. If not needed, the time slots are not assigned at all. It should be understood that the duration of the length of the time slots 504, 506 may be varied depending on the number and type of information requested by the encoder 300 via the start command message 502. A dummy start command 508 may be used to have the decoders 400 return any resident information. Thus, it should be appreciated that the decoders 400 only transmit status and ready information when requested and at specific times. As illustrated by this figure, each encoder start command is directed to a different collection or group of sources. The operations of each group in this example overlaps with the operations which were initiated in the previous group.

Another exemplary communication protocol synchronizes the return of seismic source information during a synchronization of a start of one or more seismic sources. The seismic source information may include the current or previous status of one or more seismic sources. This status information for all the seismic sources may be assigned a timeslot as discussed previously. The seismic source information may include quality control information from one or more previous initiations of one or more seismic sources. This status information for all the seismic sources may also be assigned a timeslot. It should be understood that information relating to a previous sweep may be present because the decoders 400 do not send such information unless requested. Thus, quality control information from a given sweep may not be returned until the commencement of the successive sweep.

In some embodiments, a navigation system, a computer with a processor, or seismic source controller may be used to combine two or more current or previous status messages from one or more seismic sources. The combined status messages may be transmitted via a protocol used for synchronizing one or more seismic sources and returning the information in a synchronized manner.

The above signal communications may be done wirelessly and/or with hardwires. The communication protocol may consist of an analog or digital protocol or method of synchronization.

The term “seismic devices” means any device that is used in a seismic spread, including, but not limited to sensors, sensor stations, receivers, transmitters, power supplies, control units, etc. The disclosure herein is provided in reference to particular embodiments and processes to illustrate the concepts and methods. Such particular embodiments and processes are not intended to limit the scope of the disclosure or the claims. All such modifications within the scope of the claims and disclaimers are intended to be part of this disclosure.

What is claimed is:

1. A method for controlling seismic data acquisition communication, comprising:
synchronizing a start of one or more seismic sources by sending an encoder message that includes start information and a request for seismic source information; and
synchronizing a return of a decoder message from at least one decoder, the decoder message being responsive to the encoder message.

2. The method of claim 1, further comprising transmitting the encoder and decoder messages by one of: (i) a wireless communication system, and (ii) hardwire.

3. The method of claim 1, wherein the encoder message and the decoder message are transmitted by one of: (i) a seismic recording system, (ii) source control software running on a processor, and (iii) a seismic source encoder.

4. The method of claim 1, wherein the seismic source information includes at least one of: (i) a current seismic source status, and (ii) a previous seismic source status.

5. The method of claim 1, wherein the seismic source information includes quality control information from a previous initiation of one or more seismic sources.

6. The method of claim 1, wherein the seismic source information includes: (i) a current seismic source status, (ii) a previous seismic source status, and (iii) quality control information from a previous initiation of one or more seismic sources.

7. The method of claim 1, wherein the operations and related communications are initiated in a manner which overlaps with other previous ongoing operations.

8. A method for controlling seismic data acquisition communication, comprising:
synchronizing a return of requested seismic source information via a decoder message during the synchronization of a start of one or more seismic sources.

9. The method of claim 8, further comprising assigning a time slot dynamically for the decoder message that includes the return status information for one or more seismic sources.

10. The method of claim 8, further comprising assigning a time slot dynamically for the decoder message that includes quality control information messages relating to an initiation of at least one seismic source.

11. The method of claim 8, further comprising combining two or more status messages from one or more seismic sources using one of: (i) a navigation system, (ii) a computer with a processor, and (iii) a seismic source controller.

12. The method of claim 8, further comprising combining two or more quality control information messages from one or more previous initiations of one or more seismic sources using one of: (i) a navigation system, (ii) a computer with a processor, and (iii) a seismic source controller.

13. The method of claim 8, wherein the synchronization of a start command may be synchronous timing based on one of: (i) an analog protocol, (ii) a digital protocol, (iii) a GPS time, and (iv) an artificial time that is created by an encoder and a decoder.
